(19) United States
(12) Patent Application Publication
(10) Pub. No.: US 2013/0290686 A1
(43) Pub. Date: Oct. 31, 2013

(54) INTEGRATED CIRCUIT DEVICE AND METHOD FOR CALCULATING A PREDICATE VALUE

(71) Applicants: Yuval Peled, Kiryat Ono (IL); Itzhak Barak, Kadima (IL); Idan Rozenberg, Raanana (IL); Doron Schupper, Rehovot (IL); Lev Vaskevich, Rehovot (IL)

(72) Inventors: Yuval Peled, Kiryat Ono (IL); Itzhak Barak, Kadima (IL); Idan Rozenberg, Raanana (IL); Doron Schupper, Rehovot (IL); Lev Vaskevich, Rehovot (IL)

(73) Assignee: Freescale Semiconductor, Inc., Austin, TX (US)

(21) Appl. No.: 13/977,082

(22) PCT Filed: Jan. 21, 2011
(86) PCT No.: PCT/IB11/50275

§ 371 Date: Jun. 28, 2013

(51) Int. Cl. G06F 9/30; G06F 7/57

(52) U.S. Cl. CPC G06F 9/3001; G06F 7/57
USPC 712/222

(57) ABSTRACT

An integrated circuit device comprises at least one instruction processing module arranged to perform branch predication. The at least one instruction processing module comprises at least one predicate calculation module arranged to receive as an input at least one result vector for a predicate function and at least one conditional parameter value therefor and output a predicate result value from the at least one result vector based at least partly on the at least one received conditional parameter value.

### FIELD OF THE INVENTION

The field of this invention relates to an integrated circuit device and a method for calculating a predicate value.

### BACKGROUND OF THE INVENTION

In the field of computer architecture design, it is known for branch predication to be used for mitigating the processing costs that are typically associated with conditional branches of software code, in particular branches to short sections of code. Branch predication is achieved by allowing each instruction to conditionally either perform an operation or do nothing. With branch predication, each instruction is associated with a predicate and will only be executed if the predicate is ‘true’. In this manner all possible branch paths may be followed within the processing pipeline, with the ‘correct’ path being ‘kept’ (executed) and all other paths being discarded based on the predicate values. The main purpose of predication is to avoid jumps over small sections of program code, thereby increasing the effectiveness of pipelined execution and avoiding problems with caching. In addition, functions that are traditionally computed using simple arithmetic and bitwise operations may be quicker to compute using predicated instructions. Furthermore, predicated instructions with different predicates can be combined with unconditional code, thereby allowing better instruction scheduling and, thus, better performance. Further still, predication enables elimination of unnecessary branch instructions, thereby making the execution of unnecessary branches, such as those that make up loops, faster by lessening the load on branch prediction mechanisms.

Predicates are also used to control conditional execution of instructions, and as such their respective conditions are required to be calculated in order for the predicate values to be set. Complex conditions require calculating complex Boolean functions. Typically, such calculations are performed over several cycles. For example, performing such complex calculations may comprise moving predicate registers to general purpose registers and using the CPU's (Central Processing Unit's) execution units to perform the calculations before moving the results back to the predicate registers. Alternatively, the CPU may provide a predetermined set of Boolean operations that may be performed directly on the contents of the predicate registers.

Applications are becoming increasingly more demanding in their requirements for the efficiency of processing devices, such as CPUs and the like, to execute application program code. Accordingly, there is an increasing need for CPUs and the like to minimise the number of cycles required to execute instructions, including in the case of branch predication minimizing the number of cycles required to perform conditional calculations and/or the number of predicates used, which can accelerate control code performance.

### SUMMARY OF THE INVENTION

The present invention provides an integrated circuit device and a method for calculating a predicate value as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 illustrates a simplified block diagram of an example of part of a instruction processing module.

FIG. 2 illustrates a simplified example of a predicate calculation module.

FIG. 3 illustrates a relationship between a Boolean function, truth table and result vector.

FIGS. 4 and 5 illustrate simplified flowcharts of an example of a method for calculating a predicate value.

### DETAILED DESCRIPTION

Examples of the present invention will now be described with reference to an example of an instruction processing architecture, such as a central processing unit (CPU) architecture. However, in other examples, the present invention may not be limited to the specific instruction processing architecture herein described with reference to the accompanying drawings, and may equally be applied to alternative architectures. For the illustrated example, an instruction processing architecture is provided that comprises separate data and address registers. However, in some examples, separate address registers need not be provided, as data registers may be used to provide address storage. Furthermore, for the illustrated examples, the instruction processing architecture is shown as comprising four data execution units. Some examples of the present invention may equally be implemented within an instruction processing architecture comprising any number of data execution units, and not necessarily four. Additionally, because the illustrated example embodiments of the present invention may, for the most part, be implemented using electronic components and circuits known to those skilled in the art, details will not be explained in any greater extent than that considered necessary as illustrated below, for the understanding and appreciation of the underlying concepts of the present invention and in order not to obfuscate or distract from the teachings of the present invention.

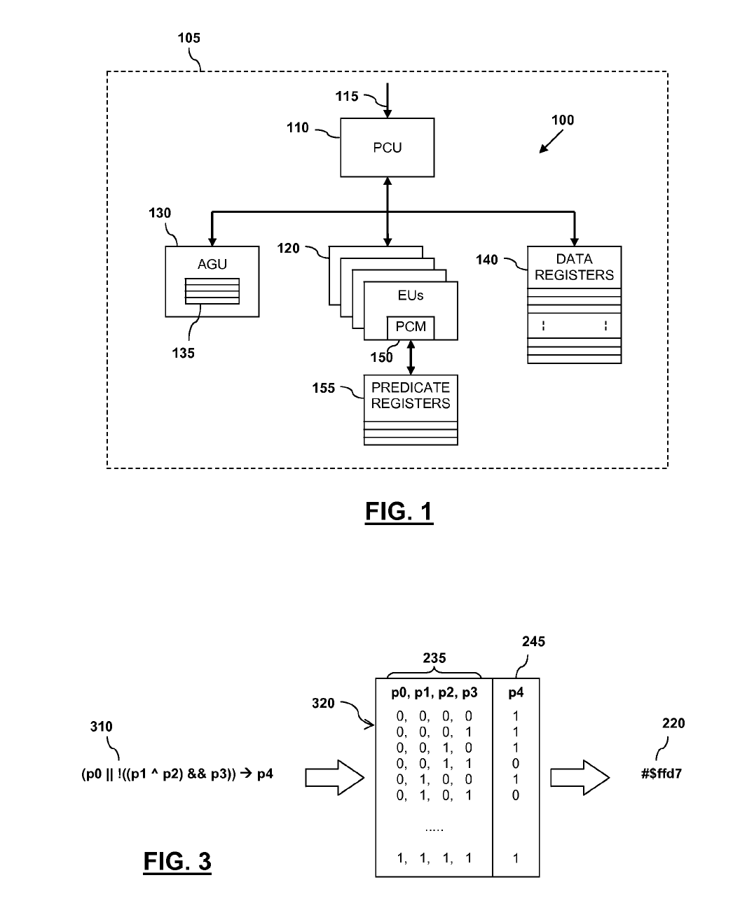

Referring first to FIG. 1, there is illustrated a simplified block diagram of an example of part of an instruction processing module 100 adapted in accordance with some example embodiments of the present invention. For the illustrated example, the instruction processing module 100 forms a part of an integrated circuit device, illustrated generally at 105, and comprises at least one program control unit (PCU) 110, one or more execution unit modules 120, at least one address generation unit (AGU) 130 and a plurality of data registers, illustrated generally at 140. The PCU 110 is arranged to receive instructions to be executed by the instruction processing module 100, as illustrated generally at 115, and to cause an execution of operations within the instruction processing module 100 in accordance with the received instructions. For example, the PCU 110 may receive an instruction, for example stored within an instruction buffer (not shown), where the received instruction requires one or more operations to be performed on one or more bits/bytes/words/etc. of data. A data ‘bit’ typically refers to a single unit of binary data comprising either a logic ‘1’ or logic ‘0’, whilst a ‘byte; typically refers to a block of 8 bits. A data ‘word’ may comprise one or more bytes of data, for example two bytes (16 bits) of data, depending upon the particular DSP architecture. Upon receipt of such an instruction, the PCU 110 generates and outputs one or more micro-instructions and/or control signals to the various other components within the instruction processing module 100, in order for the required operations to be performed. The AGU 130 is arranged to generate address values for accessing system memory (not shown), and may comprise one or more address registers as illustrated generally at 135. The data registers 140 provide storage for data fetched from system memory, and on which one or more operation(s) is/are to be performed, and from which data may be written to system memory. The execution modules 120 are arranged to perform operations on data (either provided directly thereto or stored within the data registers 140) in accordance with micro-instructions and control signals received from the PCU 110. As such, the execution modules 120 may comprise arithmetic logic units (ALUs), etc.

As previously mentioned, applications are becoming increasingly more demanding in their requirements for the efficiency of processing devices such as CPUs and the like to execute application program code. Accordingly, there is an increasing need for CPUs and the like to minimise the number of cycles required to execute instructions, including in the case of branch predication minimizing the number of cycles required to perform condition calculation and/or the number of predicates used, which can accelerate control code performance.

Thus, in accordance with an example embodiment of the present invention, the instruction processing module 100 may be arranged to perform branch predication, and comprises at least one predicate calculation module arranged to receive, as inputs, at least one result vector for a predicate function and at least one conditional parameter value therefore. The instruction processing module 100 may also be arranged to output a predicate value from the result vector based at least partly on the at least one received conditional parameter value. For the illustrated example, the at least one predicate calculation module forms an integral part of an execution module 120, and is illustrated generally at 150. As such, it is contemplated that one or more of the execution module 120 may comprise such a predicate calculation module. However, in other examples, one or more predicate calculation modules may additionally and/or alternatively be provided as discrete (stand alone) functional units within the instruction processing module 100.

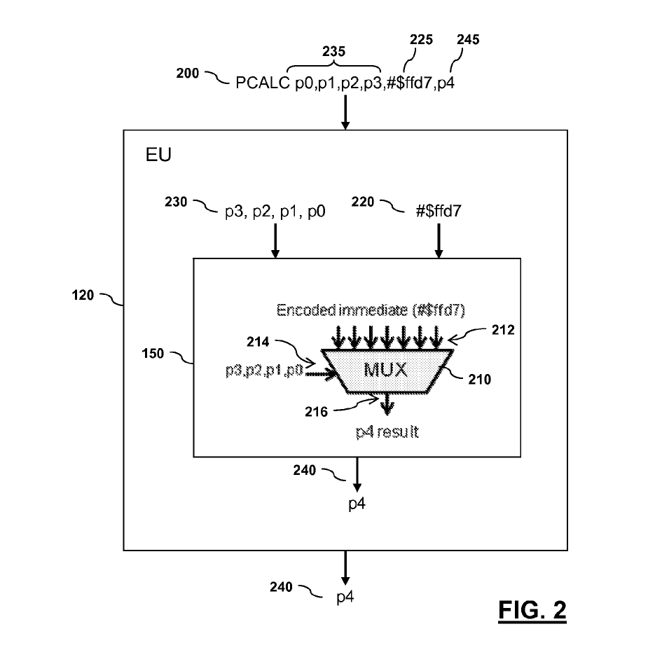

FIG. 2 illustrates a simplified example of a predicate calculation module 150 adapted in accordance with some example embodiments of the present invention. For the illustrated example the predicate calculation module 150 forms an integral part of an execution module 120, and is arranged to receive as inputs at least one result vector 220 for a predicate function and at least one conditional parameter value(s) 230 therefor, and to output a predicate value 240 from the result vector 220 based at least partly on the received at least one conditional parameter value 230. For the specific example illustrated in FIG. 2, the predicate calculation module 150 is in a form of multiplexing circuitry illustrated generally at 210. The multiplexing circuitry 210 comprises a first set of inputs, illustrated generally at 212, arranged to receive the at least one result vector 220, and a second set of inputs, illustrated generally at 214, arranged to receive the at least one conditional parameter value(s) 230. The multiplexing circuitry 210 further comprises an output, illustrated generally at 216, arranged to output the predicate value 240 from the at least one result vector 220 in accordance with the one or more conditional parameter values 230.

Predicates are used to control conditional execution of instructions, and as such their respective conditions are required to be calculated in order for the predicate values to be set. Complex conditions require calculating complex Boolean functions. An example of such a Boolean function may comprise:

(p0 ∥ !((p1 ̂ p2)&& p3))→p4 [1]

where p0, p1, p2 and p3 represent predicate registers containing conditional parameter values within the function, and p4 represents a predicate register into which the result of the function is to be loaded.

Conventionally, such calculations are performed over several cycles. For example, performing such calculations may comprise moving the conditional parameter values from predicate registers to general purpose registers and using one or more execution modules to perform the calculations over several execution cycles, before moving the results back to the predicate registers. Alternatively, the execution modules may comprise a predetermined set of Boolean operations that may be performed directly on the contents of the predicate registers. In either case, the above function is required to be calculated as follows:

XOR p1, p2, p2

AND p2, p3, p2

NOT p2, p2

OR p2, p0, p4

Thus, for such conventional implementations, four execution cycles are required to calculate a result for the above function.

Conversely, for the illustrated example of the present invention, by encoding the possible results for such a function within the at least one result vector 220, and outputting the appropriate predicate value 240 from the at least one result vector 220 in accordance with the one or more conditional parameter values 230, a predicate value may be advantageously calculated in a single execution cycle.

For example, and as illustrated in FIG. 3, a Boolean function, such as the Boolean function illustrated at 310, may be expressed in terms of its truth table, as illustrated generally at 320. The truth table 320 may comprise a column for each of the conditional parameter values 230 of the Boolean function 310, and a column for the result value 240 of the function. Each row of the truth table 320 may comprise one possible permutation of the at least one conditional parameter value(s) 230, and the appropriate result value 240 for that permutation of the at least one conditional parameter value(s) 230, with the truth table 320 comprising all possible permutations of the conditional parameter values for the Boolean function 310. In this manner, the result column of the truth table comprises a result value 240 for every permutation of conditional parameter values 230, which may be used to provide a result vector for the Boolean function 310, such as illustrated at 220 as a hexadecimal value in FIG. 3.

Thus, by providing such a result vector 220 to the predicate calculation module 150 along with a current permutation of the at least one conditional parameter value(s) 230, the at least one conditional parameter value(s) 230 may be used as selectors within the predicate calculation module 150, for selecting the appropriate predicate result value 240 from the at least one result vector 220 for that permutation of the at least one conditional parameter value(s) 230.

Typically, each permutation of the at least one conditional parameter value(s) 230 may be represented within the truth table 320 as a string of n bits, and thus interpreted as a binary number of n bits. In this manner, each permutation of the at least one conditional parameter value(s) 230 may be interpreted as comprising a unique binary number of n bits. By ordering the permutations of the at least one conditional parameter value(s) 230 in, say, ascending values within the truth table 320, a systematic and predictable ordering of all 2ⁿ possible permutations of conditional parameter values 230, and thereby of all 2ⁿ possible result values 240 within the result vector 220 may be achieved. As a result, the predicate calculation module 150 may be configured to systematically and predictably select the appropriate predicate result value 240 from the result vector 220 provided thereto, based on the received at least one conditional parameter value(s) 230.

In accordance with some example embodiments of the present invention, the at least one result vector 220, or at least an indication thereof, together with the one or more conditional parameter values 230, or at least an indication thereof, may be encoded within a single predicate calculation instruction, such as illustrated at 200 in FIG. 2, to be executed by the execution module 120. For example, such a single predicate calculation instruction 200 may comprise the at least one result vector 220 and the one or more conditional parameter values encoded directly therein. In this manner, the execution module 120 may be arranged, upon receipt of such a single predicate calculation instruction 200, to extract the at least one result vector 220 and the one or more conditional parameter values 230, and to provide the extracted result vector 220 and the one or more conditional parameter value(s) 230 to the predicate calculation module 150.

Conversely, in other examples, the single predicate calculation instruction 200 may additionally and/or alternatively comprise, say, one or more register identifiers for identifying one or more registers containing the at least one result vector 220 and/or one or more conditional parameter value(s) 230. Such registers may comprise general purpose data registers, such as illustrated at 140 in FIG. 1, or may comprise dedicated predicate registers, such as illustrated at 155 in FIG. 1. Accordingly, upon receipt of such a predicate calculation instruction 200, the execution module 120 may be arranged to extract such register identifiers therefrom, to retrieve the at least one result vector 220 and/or one or more conditional parameter value(s) 230 from the identified register(s) and to provide the extracted/retrieved at least one result vector 220 and the one or more conditional parameter value(s) 230 to the predicate calculation module 150. In a still further alternative example, one or more conditional parameter value(s) 230 may be provided within defined registers.

Accordingly, such a predicate calculation instruction 200 may only comprise a result vector encoded therein (or a register identifier therefor), and the execution module 120 may be arranged, upon receipt of such a predicate calculation instruction 200, to extract the encoded at least one result vector 220 from the received predicate calculation instruction 200 (or retrieve the at least one result vector 220 from the register identified therein), and to retrieve the one or more conditional parameter value(s) 230 from the defined registers.

For the illustrated example, the predicate calculation instruction 200 further comprises an indication 245 of a storage location at which the predicate value is to be stored. For example, such a storage location may comprise a general purpose data register, such as illustrated at 140 in FIG. 1, or may comprise a dedicated predicate register, such as illustrated at 155 in FIG. 1. Accordingly, the execution module 120 may be further arranged, upon receipt of such a predicate calculation instruction 200, to extract the indication 245 of the at least one storage location and, upon output of the predicate result value 240 by the at least one predicate calculation module 150, store the predicate result value 240 within the storage location in accordance with the extracted indication 245.

Substantially any Boolean function is capable of being represented by way of a truth table. Accordingly, a predicate calculation module 150, as hereinbefore described with reference to the accompanying drawings, is capable of calculating a predicate result value 240 for substantially any Boolean function for which it is provided an appropriate result vector 220, with the only substantial limitation being the number n of the one or more conditional parameter value(s) 230 and the size (2ⁿ) of the at least one result vector 220 that the predicate calculation module 150 is capable of receiving. Furthermore, only a single predicate calculation instruction 200 and a single execution cycle are required for calculating the predicate result value 240, irrespective of the complexity of the underlying Boolean function. Accordingly, such a predicate calculation module 150 may enable substantially any predicate result value 240 to be calculated (for Boolean functions comprising up to n conditional parameters) using only a single predicate calculation instruction 200, and requiring only a single execution cycle, irrespective of the complexity of the underlying Boolean function.

In some examples, a predicate calculation module 150 may be implemented by way of multiplexing circuitry, as generally illustrated in FIG. 1. Accordingly, such a predicate calculation module 150 may comprise a low hardware cost to be implemented. Furthermore, because the underlying Boolean function required for calculating the predicate value is represented within the at least one result vector 220, only a single, compact predicate calculation instruction need be included within the execution module instruction set in order to enable a calculation of substantially any predicate result value 240 (for Boolean functions comprising up to n conditional parameters), irrespective of the complexity of the underlying Boolean function.

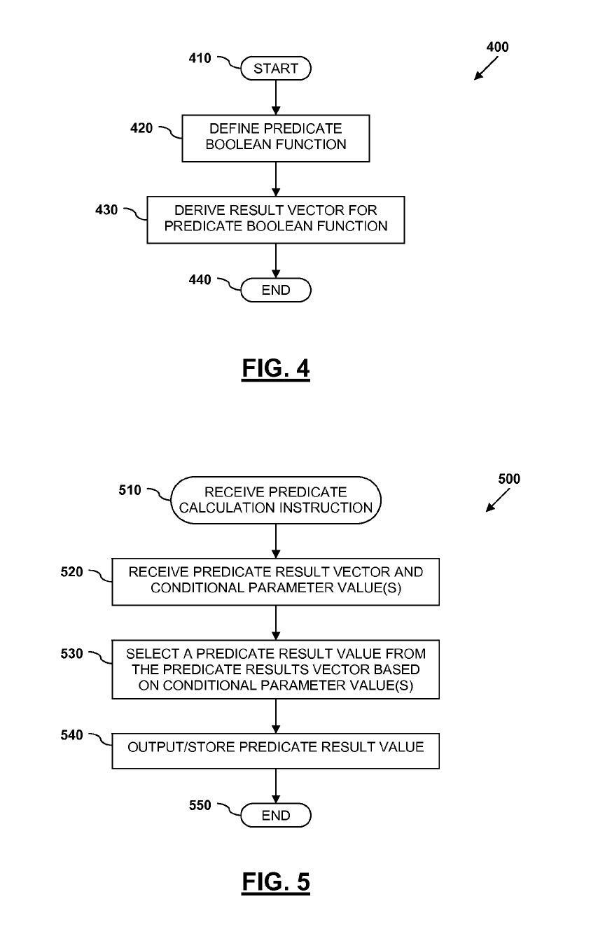

FIGS. 4 and 5 illustrate simplified flowcharts 400, 500 of an example of a method for calculating a predicate value for use during branch predication within an instruction processing module, for example as may be implemented within the instruction processing module 100 of FIG. 1. Referring first to FIG. 4, there is illustrated a simplified flowchart 400 of an example of a first part of a method in which a result vector for a Boolean function for calculating a predicate value is derived. This first part of the method starts at step 410, and moves on to step 420 where a Boolean function for the calculating the predicate value is defined. Next, at step 430, a result vector is derived such that the result vector comprises result values for all permutations of conditional parameter values for the defined Boolean function. For example, as illustrated in FIG. 3, the result vector may be derived from a result column of a truth table for the defined Boolean function. The method then ends, at step 440.

Referring now to FIG. 5, there is illustrated a simplified flowchart 500 of an example of a further part of the method in which a predicate result value is calculated. This further part of the method starts at step 510 with a receipt of a predicate calculation instruction, for example such as the predicate calculation instruction 200 of FIG. 2. Next, at step 520, a result vector and at least one conditional parameter value is/are received. For example, the result vector and/or conditional parameter value(s) may be encoded within the received instruction, and thus may simply be extracted therefrom. Alternatively, in one example, step 520 may comprise retrieving the result vector and/or one or more conditional parameter value(s) from one or more registers identified within the received instruction and/or predefined registers. The method then moves on to step 530 where a predicate result value is selected from the at least one result vector based on the at least one conditional parameter value(s). The selected predicate result value is then output or stored (for example within a register identified within the received instruction) in step 540, and the method ends at step 550.

In the foregoing specification, the invention has been described with reference to specific examples of embodiments of the invention. It will, however, be evident that various modifications and changes may be made therein without departing from the broader spirit and scope of the invention as set forth in the appended claims.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein can be designed as either negative or positive logic signals. Therefore, in alternate embodiments, those signals described as positive logic signals may be implemented as negative logic signals, and those signals described as negative logic signals may be implemented as positive logic signals.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality. For example, and as previously mentioned, for the illustrated examples the predicate calculation module 150 has been illustrated and described as comprising an integral part of an execution module 120. However, it is contemplated that a predicate calculation module adapted in accordance with the present invention may equally be implemented as a generally discrete, stand alone function element, or integrated within an alternative functional module.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediary components. Likewise, any two components so associated can also be viewed as being “operably connected”, or “operably coupled”, to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an”, as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an”. The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. An integrated circuit device comprising at least one instruction processing module arranged to perform branch predication, the at least one instruction processing module comprising at least one predicate calculation module arranged to:
receive as an input at least one result vector for a predicate function and at least one conditional parameter value therefor; and
output a predicate result value from the at least one result vector based at least partly on the at least one received conditional parameter value.

2. The integrated circuit device of claim 1 wherein the at least one predicate calculation module comprises multiplexing circuitry.

3. The integrated circuit device of claim 1 Of claim 2 wherein the at least one result vector comprises a predicate result value for a plurality of permutations of the at least one conditional parameter value within a defined Boolean function.

4. The integrated circuit device of claim 1 wherein the instruction processing module further comprises at least one execution module arranged to receive at least one predicate calculation instruction comprising at least an indication of the at least one result vector.

5. The integrated circuit device of claim 4, wherein upon receipt of such an at least one predicate calculation instruction, the at least one execution module is arranged to extract the at least an indication of the at least one result vector therefrom and provide the at least one result vector to the at least one predicate calculation module.

6. The integrated circuit device of claim 4 wherein the at least one predicate calculation instruction further comprises at least an indication of the at least one conditional parameter value.

7. The integrated circuit device of claim 6, wherein the at least one execution module is further arranged, upon receipt of such an at least one predicate calculation instruction, to extract the at least indication of the at least one conditional parameter value therefrom and provide the at least one conditional parameter value to the at least one predicate calculation module.

8. The integrated circuit device of claim 4 wherein the at least one predicate calculation instruction further comprises an indication of at least one storage location at which the predicate result value is to be stored.

9. The integrated circuit device of claim 8 wherein the at least one execution module is further arranged, upon receipt of such an at least one predicate calculation instruction, to extract the indication of the at least one storage location and, upon output of the predicate result value by the at least one predicate calculation module, store the predicate result value within the storage location in accordance with the extracted indication.

10. A method for calculating a predicate result value for use during branch predication within an instruction processing module, the method comprising:
receiving at least one result vector for a predicate function and at least one conditional parameter value therefor; and
selecting a predicate result value from the at least one result vector based at least partly on the received at least one conditional parameter value.

11. The method of claim 10 wherein the method further comprises deriving the at least one result vector such that the at least one result vector comprises result values for a plurality of permutations of conditional parameter values within a defined Boolean function.
